(19) United States
(12) Patent Application Publication
(10) Pub. No.: US 2016/0291898 A1
(43) Pub. Date: Oct. 6, 2016

(54) METHODS AND SYSTEMS FOR PROCESSING FILES IN MEMORY

(71) Applicant: Samsung Electronics Co., Ltd., Suwon-si (KR)

(72) Inventors: Uri BEITLER, Ramat Gan (IL); Jun Jin KONG, Yongin-si (KR)

(21) Appl. No.: 14/677,588

(22) Filed: Apr. 2, 2015

(51) Int. Cl. G06F 3/06

(52) U.S. Cl. CPC G06F 3/0643; G06F 3/0604; G06F 3/0673

(57) ABSTRACT

At least one example embodiment discloses a memory storage device including a first memory and a controller configured to program a file into the first memory, read the file from the first memory upon receiving a request for the file from an external host, the request identifying requested manipulations to the file, and manipulate the file in accordance with the request.

### BACKGROUND

A host, such as a PC user, uses a storage system to store files such as multimedia files.

Multimedia files (e.g., JPEG images and MPEG videos) are popular in many device applications. Conventionally, multimedia files are handled similarly as any other file stored on the storage system.

In an example, the host may not always use a high resolution multimedia file. If a host requests to read an image with a lower resolution, the entire image is read to cache, the resolution is lowered and then the image may be re-saved on the memory (e.g., flash). Sometimes both the image having the original resolution and the lower resolution are saved on the memory. As a result, the host and a controller of the storage system pass the entire image twice, once at a full resolution for read and once at the lower resolution to write.

Other examples of file manipulation include contrast adjustment, color enhancement, rotation, skew, etc., which are performed in a similar manner, in terms of exchanging a file between the host and memory, as altering the resolution.

### SUMMARY

At least one example embodiment discloses a memory storage device including a first memory and a controller configured to program a file into the first memory, read the file from the first memory upon receiving a request for the file from an external host, the request identifying requested manipulations to the file, and manipulate the file in accordance with the request.

In an example embodiment, the file is a multimedia file.

In an example embodiment, the controller is configured to change a resolution of an image in the file based on the request, the manipulated file being a file with the image having the changed resolution.

In an example embodiment, the controller is configured to send the manipulated file to the host.

In an example embodiment, the first memory is configured to save only one copy of the image.

In an example embodiment, the controller is configured to process the request such that the file is not passed to the host upon receiving the request.

In an example embodiment, the controller is configured to perform lossless decoding before manipulating the file.

In an example embodiment, the controller is configured to perform lossless encoding of the manipulated file.

In an example embodiment, the first memory includes a three-dimensional memory array.

In an example embodiment, the three dimensional memory array comprises a plurality of memory cells, each of the memory cells including a charge trap layer.

In an example embodiment, word lines and/or bit lines in the three-dimensional memory array are shared between levels.

At least one example embodiment discloses a method of manipulating a multimedia file. The method includes programming the multimedia file into a first memory, reading the multimedia file from the first memory upon receiving a request for the multimedia file from an external host, the request identifying requested manipulations to the multimedia file and manipulating the multimedia file in accordance with the request.

In an example embodiment, the manipulating includes changing a resolution of an image in the multimedia file based on the request, the manipulated multimedia file being a multimedia file with the image having the changed resolution.

In an example embodiment, the method further includes sending the manipulated multimedia file to the host.

In an example embodiment, the programming programs only one copy of the image into the first memory.

In an example embodiment, the method further includes sending the manipulated multimedia file to the host.

In an example embodiment, the method further includes processing the request such that the multimedia file is not passed to the host upon receiving the request.

In an example embodiment, the method further includes performing lossless decoding before manipulating the multimedia file.

In an example embodiment, the method further includes performing lossless encoding of the manipulated multimedia file.

### BRIEF DESCRIPTION OF THE DRAWINGS

Example embodiments will become more appreciable through the description of the drawings in which:

FIG. 1 is a block diagram schematically illustrating a storage system according to an example embodiment;

FIG. 2A is a block diagram illustrating an example embodiment of a device controller shown in FIG. 1;

FIG. 2B is a block diagram illustrating an example embodiment of the device controller shown in FIG. 1;

FIG. 3 is a flow chart illustrating an example embodiment of a method for manipulating a multimedia file;

FIG. 4 is a block diagram of an electronic apparatus adopting a memory system according to an example embodiment;

FIG. 5 is a block diagram of a memory card system according to an example embodiment; and

FIG. 6 is a block diagram showing an example of network configuration according to an example embodiment.

### DETAILED DESCRIPTION

Example embodiments will now be described more fully with reference to the accompanying drawings. Many alternate forms may be embodied and example embodiments should not be construed as limited to example embodiments set forth herein. In the drawings, like reference numerals refer to like elements.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware in existing electronic systems (e.g., nonvolatile memories universal flash memories, universal flash memory controllers, nonvolatile memories and memory controllers, digital point-and-shoot cameras, personal digital assistants (PDAs), smartphones, tablet personal computers (PCs), laptop computers, etc.). Such existing hardware may include one or more Central Processing Units (CPUs), digital signal processors (DSPs), application-specific-integrated-circuits (ASICs), field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), resistive RAM, memristors, magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors may be programmed to perform the necessary tasks, thereby being transformed into special purpose processor(s) or computer(s).

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

The term multimedia and media may be used interchangeably. A multimedia file may refer to a file including any combination of text, audio, still images, animation, video and/or interactivity content forms.

Conventionally, multimedia files are handled similarly as any other file stored on the storage system. For example, when requesting a low resolution image, the host and a controller of the storage system may pass the entire image twice, once at full resolution for read and once at the lower resolution to write. Moreover, changing the resolution is performed by software while keeping the image on cache and, in order to read an image at low resolution from the flash, the low resolution image is saved in parallel to the high resolution image.

By contrast, example embodiments disclose a controller that performs certain processing operations on the multimedia file. By performing certain processing operations on the controller, the data transferred between the host and the controller is reduced, operations which are conventionally performed by software are accelerated and, in some instances, the use of storing several versions of the same image is eliminated. Example embodiments improve transmission load due to sending a lower resolution version (i.e., less information), avoiding the redundant transmission to store the file in non-volatile memory in case multiple versions are stored and multiple transmissions due to cache limitations in a host which require retransmission of the same information while manipulating the data in the host side.

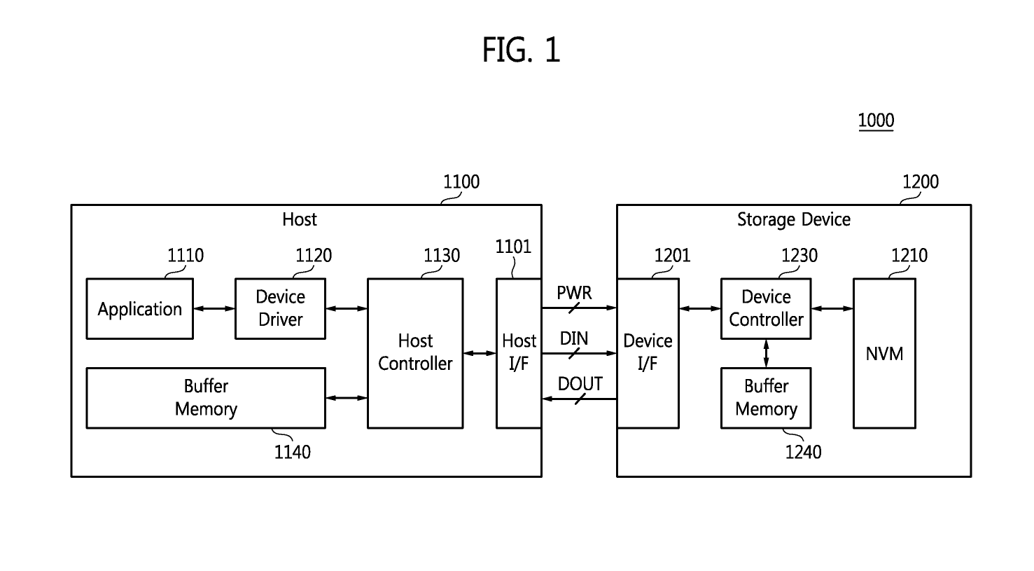

FIG. 1 is a block diagram schematically illustrating a storage system according to an example embodiment.

Referring to FIG. 1, the storage system 1000 includes a host 1100 and a storage device 1200.

The host 1100 includes a host interface 1101, and the storage device includes a device interface 1201. The storage device 1200 and the host 1100 are connected to one another through the interfaces 1101 and 1201. The host interface 1101 and the device interface 1201 may be standardized interfaces such as a UFS (Universal Flash Storage) interface, a SATA (serial advanced technology attachment (ATA)) interface, a SCSI (Small Computer Small Interface), a SAS (serial attached SCSI), Peripheral Component Interconnect (PCI), and express interfaces of those listed above, for example. The host interface 1101 and the device interface 1201 are connected by data lines DIN and DOUT for exchanging data and/or signals, and by power lines PWR for providing power. In the example shown in FIG. 1, the host interface 1101 provides power to the device interface 1201 via the power line PWR.

Still referring to FIG. 1, the host 1100 further includes a host controller 1130, a buffer memory 1140, an application 1110 and a device driver 1120.

According to at least some example embodiments, the application 1110 may refer to one or more application programs executed on the host 1100. The application 1110 and/or the device driver 1120 may be implemented by hardware, software and/or firmware. The host controller 1130 receives data from and sends commands (e.g., read, write, erase) and/or data to the storage device 1200 through the host interface 1101.

According to at least some example embodiments, the buffer memory 1140 may be used as a main memory and/or a cache memory of the host 1100. The buffer memory 1140 (e.g., synchronous random access memory (SRAM) and/or dynamic random access memory (DRAM)) may also be used as a driving memory to drive software such as the application 1110 and/or the device driver 1120.

Still referring to FIG. 1, the storage device 1200 further includes a nonvolatile memory 1210, a device controller (also referred to as a memory controller) 1230 and a buffer memory 1240. In this example, the storage device 1200 may be a data storage device based on a nonvolatile memory such as a flash memory or the like. For example, the nonvolatile memory 1210 may be a flash memory, a magnetic random access memory (MRAM), a phase change RAM (PRAM), a ferroelectric RAM (FeRAM), etc.

The non-volatile memory may be a two-dimensional (2D) or three dimensional (3D) memory array. A 3D memory array is monolithically formed in physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

The 3D memory array includes vertical NAND strings that are vertically oriented such that at least one memory cell is located over another memory cell. The at least one memory cell may comprise a charge trap layer.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and U.S. Patent Application Publication No. 2011/0233648.

The device controller 1230 controls an overall operation of the nonvolatile memory 1210 including, for example, write operations, read operations, erase operations, encoding/decoding, error correction, etc. The device controller 1230 exchanges data with the nonvolatile memory 1210 and/or the buffer memory 1240 through an address and/or data bus. The device controller 1230 will be discussed in more detail later.

The buffer memory 1240 (e.g., synchronous random access memory (SRAM) and/or dynamic random access memory (DRAM)) temporarily stores data to be stored in the nonvolatile memory 1210 and/or data read from the nonvolatile memory 1210. The buffer memory 1240 may be implemented by a volatile and/or nonvolatile memory and may also hold metadata, such as mapping tables, log structured address journal, etc.

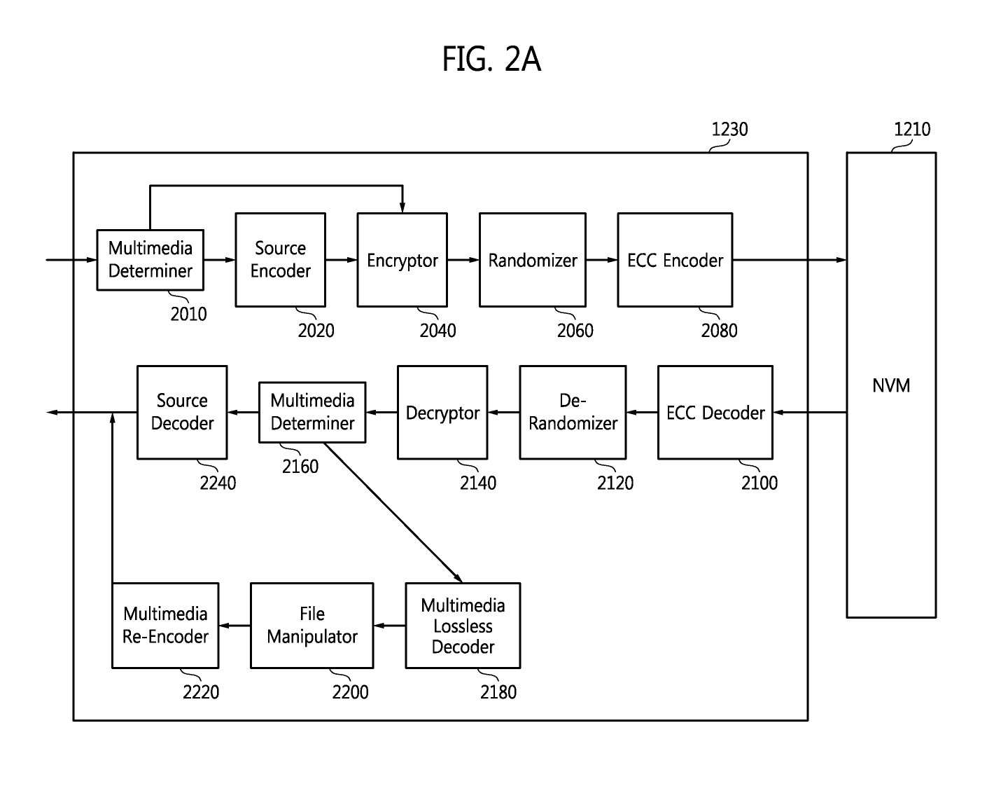

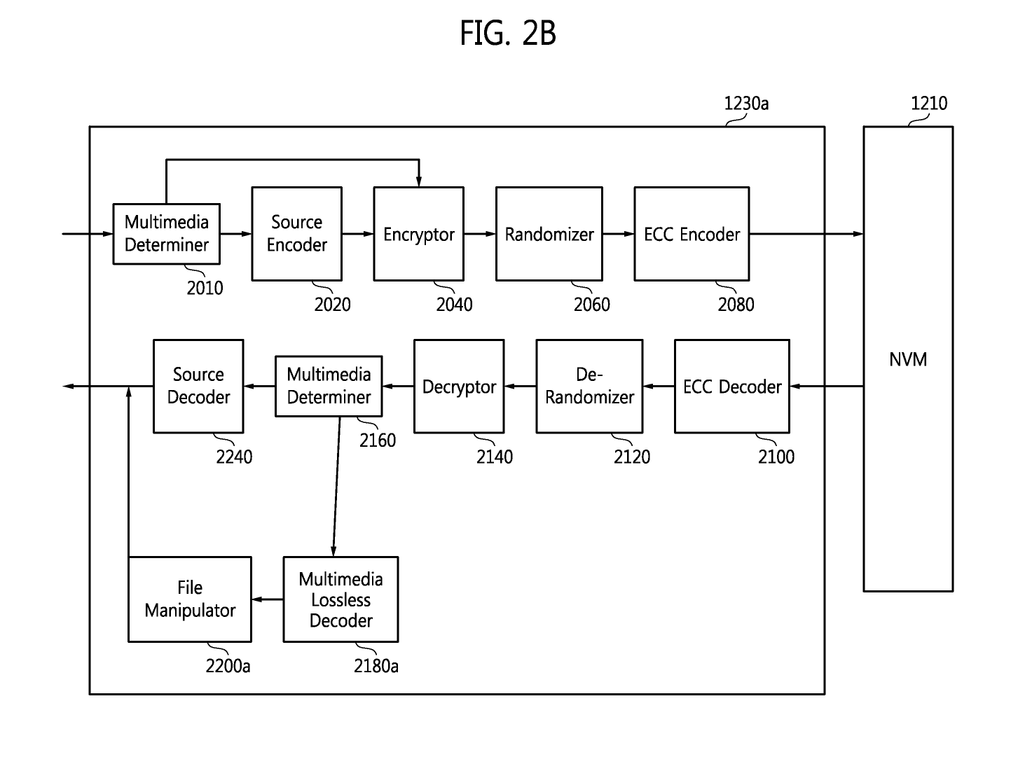

FIG. 2A is a block diagram illustrating an example embodiment of the device controller 1230 shown in FIG. 1. The device controller includes a multimedia determiner 2010, a source encoder 2020, an encryptor 2040, a randomizer 2060, an error correcting code (ECC) encoder 2080, an ECC decoder 2100, a de-randomizer 2120, a decryptor 2140, a multimedia determiner 2160, a multimedia lossless decoder 2180, a file manipulator 2200, a multimedia re-encoder 2220 and a source decoder 2240.

The multimedia determiner 2010, the source encoder 2020, the encryptor 2040, the randomizer 2060, the error correcting code (ECC) encoder 2080, the ECC decoder 2100, the de-randomizer 2120, the decryptor 2140, the multimedia determiner 2160, the multimedia lossless decoder 2180, the file manipulator 2200, the multimedia re-encoder 2220 and the source decoder 2240 may be implemented in hardware. Such existing hardware may include one or more Central Processing Units (CPUs), digital signal processors (DSPs), application-specific-integrated-circuits (ASICs), field programmable gate arrays (FPGAs) or the like configured as special purpose machines to perform the functions of the multimedia determiner 2010, the source encoder 2020, the encryptor 2040, the randomizer 2060, the error correcting code (ECC) encoder 2080, the ECC decoder 2100, the de-randomizer 2120, the decryptor 2140, the multimedia determiner 2160, the multimedia lossless decoder 2180, the file manipulator 2200, the multimedia re-encoder 2220 and the source decoder 2240. CPUs, DSPs, ASICs and FPGAs may generally be referred to as processors and/or microprocessors.

Software may be used for mapping and sequencing (i.e., data flow control). A processor executing software may be configured as a special purpose machine to execute the software, stored in a storage medium (e.g., memory 1240).

The multimedia determiner 2010 receives a file to write to the NVM 1210. The multimedia determiner 2010 determines whether the file is a multimedia file. If the file is a multimedia file, the multimedia determiner 2010 sends the file to the encryptor 2040. If the file is not a multimedia file, the multimedia determiner 2010 sends the filed to the source encoder 2020.

In an example embodiment, the multimedia determiner 2010 may modify the host interface 1101 and the device interface 1201 to enable the host 1100 the option of passing a file-type indicator to the storage device 1200. Thus, the multimedia determiner 2010 may determine whether the file is a multimedia file based on the file-type indicator.

In another example embodiment, the multimedia determiner 2010 may attempt to identify the standardized structure of the multimedia file by analyzing the data itself (e.g., a correlator which detects a known header of the file) using any known algorithm.

Metadata is constructed of many fields, for example an ECC type, a level of compression, a randomizer seed, a logical page address, etc. These fields are stored in the NVM 1210 (either as part of the data block or in a separated region) and read with the data. A logical address (host addresses) to physical address (NVM addresses) mapping table may also be stored on the buffer 1240 in order to enable faster access to the physical addresses upon host requests. The mapping table is backed up to the NVM 1210 when power-off occurs.

The source encoder 2020 encodes a non-multimedia file using any known method such as Huffman, Deflate, Arithmetic, Dynamic Markov Compression (DMC), Pulse Position Modulation (PPM) or Context-Tree Weighting (CTW) coding. Thus, for the sake of brevity, the source encoder 2020 will not be discussed any further.

The encryptor 2040 encrypts the file (multimedia or non-multimedia) using any known method such as Delphi Encryption Compendium (DEC), Advanced Encryption Standard (AES) and RSA, for example. Thus, for the sake of brevity, the encryptor 2040 will not be discussed any further.

It should be understood that in other example embodiments, the controller 1230 does not include one of the multimedia determiner 2010, the source encoder 2020, the encryptor 2040 the descriptor 2140 and the source decoder 2240.

The randomizer 2060 receives the encrypted file to output randomized data. The ECC encoder 2080 receives the randomized data and generates a codeword, which is sent to the NVM 1210. The codeword generated by the ECC encoder 2080 may include the randomized data, a CRC parity and an ECC parity, for example.

When reading the file, the ECC decoder 2100 decodes the encoded codeword from the NVM 1210. The de-randomizer 2120 receives error-corrected randomized data output from the ECC decoder 2100 to output de-randomized data. In an example embodiment where a decryptor and source decoder or encryptor and source encoder are not present, the output de-randomized data is the original file input to the multimedia determiner 2010.

The decryptor 2140 decrypts the output de-randomized data and outputs the decrypted data to the multimedia determiner 2160. The multimedia determiner 2160 determines whether the decrypted data is a multimedia file.

If the decrypted data is a multimedia file, the multimedia determiner 2160 sends the decrypted data to the multimedia lossless decoder 2180. The multimedia determiner 2160 and the multimedia determiner 2010 may be different. For example, the multimedia determiner 2160 may be a parser that reads bits inserted by the multimedia determiner 2010.

It should be noted that the decrypted multimedia file is a compressed file upon being received by the multimedia lossless decoder 2180. More specifically, the decrypted multimedia file is typically compressed using a transform. Example transforms include discrete cosine transform (DCT) for MPEG and JPEG, wavelets for JPEG 2000 and other transforms. The multimedia lossless decoder 2180 decompresses a lossless part of the compression (entropy coding) in order to perform the requested manipulation on the file manipulator 2200.

The multimedia lossless decoder 2180, together with the file manipulator 2200 and the multimedia re-encoder 2220, perform certain processing operations on the multimedia file. By performing certain processing operations on the controller, the data transferred between the host and the controller is reduced, operations which are conventionally performed by software are accelerated and, in some instances, the use of storing several versions of the same image is eliminated. The file maintains its standard compliant structure.

Using JPEG as an example of the multimedia file, the multimedia lossless decoder 2180 performs entropy decoding in the discrete cosine transform (DCT) domain, which generates the quantized DCT transform coefficients of the image.

It should be understood that the multimedia lossless (entropy) decoder 2180 performs the decoding in a conventional manner as described in the various standards. In standards such as MPEG4 or h265, an entropy decoder is an arithmetic decoder.

The multimedia lossless decoder 2180 provides the decoded multimedia file to the file manipulator 2200. The file manipulator 2200 then manipulates the lossless decoded multimedia file to produce an image according to a request from the host using any known file manipulation algorithm that corresponds to the manipulation request.

For example, if the controller 1230 receives a request from the host 1100 for an image having a lower resolution than the image written to the NVM 1210, the file manipulator 2200 reduces the resolution of the image by applying any known resolution reduction algorithm on the DCT transform coefficients of the lossless decoded image.

In addition to reducing the resolution, the file manipulator 2200 may perform other operations such as rotation, skewing, resizing, removing color, etc. An example of manipulating the size of an image in the DCT domain is disclosed in A Complexity Scalable Universal DCT Domain Image Resizing Algorithm, IEEE Transactions on Circuits and Systems for Video Technology, Vol. 17, No. 4, April 2007, pp. 495-499, the entire contents of which are hereby incorporated by reference.

The file manipulator 2200 sends the manipulated file to the multimedia re-encoder 2220. The re-encoder 2220 is standard compliant. For example, the re-encoder 2220 may be implemented as an arithmetic encoder or a Huffman encoder as described in different standards.

The multimedia re-encoder 2220 re-encodes the manipulated file and sends the re-encoded file to the host 1100. The re-encoding is lossless and performs the entropy encoding. The transform or inverse transform are not implemented inside the controller 1230.

In another example embodiment, the inverse transform may be implemented in the controller if an uncompressed version of the file is to be sent to the host.

Because the device controller 1230 performs the file manipulation, the multimedia determiner 2010, the source encoder 2020, the encryptor 2040, the randomizer 2060, the error correcting code (ECC) encoder 2080, the ECC decoder 2100, the de-randomizer 2120, the decryptor 2140, the multimedia determiner 2160, the multimedia lossless decoder 2180, the file manipulator 2200, the multimedia re-encoder 2220 and the source decoder 2240 may be implemented in hardware. Moreover, the manipulations are performed in the transform domain (e.g., DCT). The term randomizer and de-randominzer may also be referred to as scrambler and de-scrambler, respectively.

While the example embodiment shown in FIG. 2A is described with the file manipulations being performed in the DCT domain, it should be understood that the file manipulations may be performed in the spatial domain.

FIG. 2B is a block diagram illustrating an example embodiment of the device controller 1230 shown in FIG. 1. A device controller 1230a, shown in FIG. 2B, is the same as the controller 1230 shown in FIG. 2A, except for the multimedia processing during a read operation. Therefore, for the sake of brevity, only the differences will be discussed.

In FIG. 2B, the multimedia determiner 2160 determines whether the decrypted data is a multimedia file.

If the decrypted data is a multimedia file, the multimedia determiner 2160 sends the decrypted data to a multimedia lossless decoder 2180a.

The multimedia lossless decoder 2180a and a file manipulator 2200a perform certain processing operations on the multimedia file.

The multimedia lossless decoder 2180a performs entropy decoding in the transform domain (e.g., DCT transform) which generates decoded transform coefficients.

The multimedia lossless decoder 2180a provides the transform coefficients to the file manipulator 2200a. The file manipulator 2200a then manipulates the lossless/partially decoded multimedia file to produce an image according to a request from the host. For example, if the controller 1230a receives a request from the host for an image having a lower resolution than the image written to the NVM 1210, the file manipulator 2200a reduces the resolution of the image using the coefficients of the decoded compressed multimedia file. The file manipulator 2200a sends the manipulated file to the host 1100.

In FIG. 2B, the manipulated file not re-encoded and sent to the host as decoded (manipulated) transform coefficients.

By performing file manipulations in the controller 1230, the operational speed of the system 1000 is increased as opposed to performing the file manipulations in software on the host 1100. As described the multimedia file may be a JPEG file or another type of file such as a movie file or an audio file. Such file operations may include color/contrast adjustment and insertion/deletion of audio/video elements, etc.

The system 1000 also reduces the load on the data lines between the storage device 1200 and the host 1100 because the manipulated multimedia file is transferred from the storage device 1200 to the host 1100. This is in contrast to conventional systems where a requested file is transferred to the host 1100, manipulated and then possibly transferred back to the storage device 1200. For example, example embodiments improve transmission load due to sending a lower resolution version (i.e., less information), avoiding the redundant transmission to store the file in the NVM 1210 in case multiple versions are stored and multiple transmissions due to cache limitations in the host 1100 which require retransmission of the same information while manipulating the data in the host side.

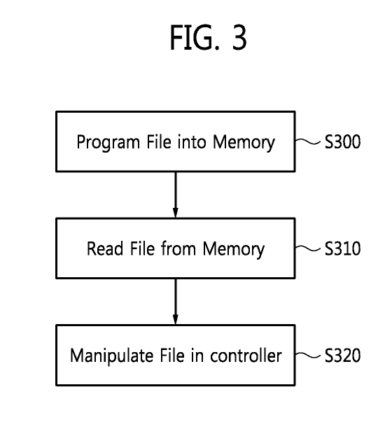

FIG. 3 illustrates a method of manipulating a multimedia file according to an example embodiment. The method shown in FIG. 3 may be performed by the controller 1230, shown in FIG. 2A, or the controller 1230a, shown in FIG. 2B.

At S300, the controller programs a multimedia file into a memory according to a write request from a host. At S310, the controller reads the multimedia file from the host. The request identifies requested manipulations to the file. At S320, the controller manipulates the file in accordance with the request, as described above with reference to FIGS. 2A-2B.

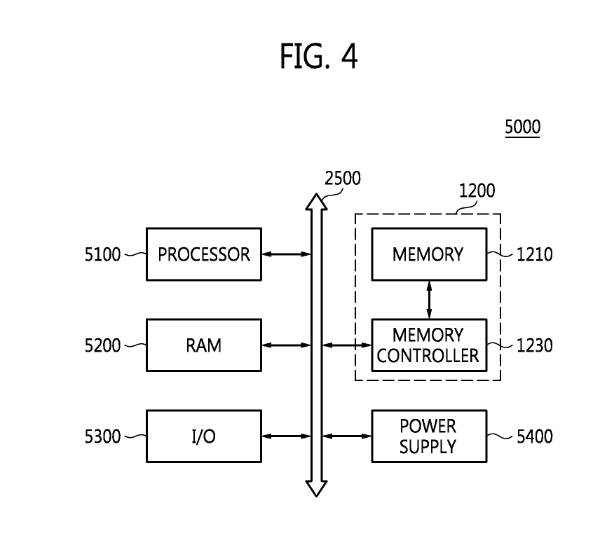

FIG. 4 is a block diagram of an electronic apparatus adopting a memory system according to an example embodiment of inventive concepts.

Referring to FIG. 4, an electronic apparatus 5000 includes a processor 5100, a random-access-memory (RAM) 5200, an input/output device 5300, a power supply device 5400, and the storage device 1200. Although not shown in FIG. 4, the electronic apparatus 5000 may further include ports that may communicate with video cards, sound cards, or universal serial bus (USB) devices, or other electronic devices. The electronic apparatus 5000 may be realized as a personal computer, or a portable electronic device such as a notebook computer, a mobile phone, a personal digital assistant (PDA), and a camera.

The processor 5100 may perform certain calculations or tasks. Accordingly, the processor 5100 may be a microprocessor or a central processing unit (CPU). The processor 5100 may communicate with the RAM 5200, the input/output device 5300, and the storage device 1200 via a bus 5500 such as an address bus, a control bus, and a data bus. In some embodiments, the processor 5100 may be connected to an expanded bus such as peripheral component interconnect (PCI) bus.

The RAM 5200 may store data that is used to operate the electronic apparatus 5000. For example, the RAM 5200 may be a dynamic RAM (DRAM), a mobile DRAM, an SRAM, a PRAM, an FRAM, an RRAM, and/or an MRAM.

The input/output device 5300 may include an input unit such as a keyboard, a keypad, or a mouse, and an output unit such as a printer or a display. The power supply device 5400 may supply an operating voltage to operate the electronic apparatus 5000.

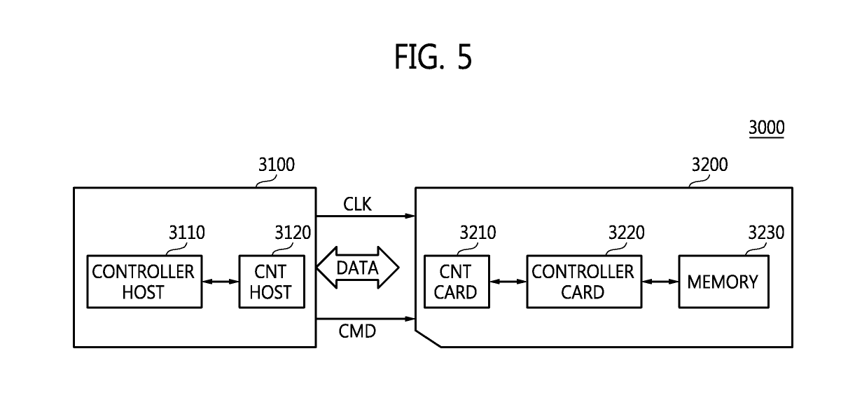

FIG. 5 is a block diagram of a memory card system including a memory system 3000 according to an example embodiment.

Referring to FIG. 5, the memory system 3000 may include a host 3100 and a memory card 3200. The host 3100 includes a host controller 3110, and a host connecting unit 3120. The memory card 3200 may include a card connecting unit 3210, a card controller 3220, and a memory device 3230.

The card controller 3220 and the memory device 3230 shown in FIG. 5 may be the device controller 1230 and the nonvolatile memory 1210, shown in FIG. 1.

The host 3100 may write data to the memory card 3200, or may read data stored in the memory card 3200. The host controller 3110 may transmit commands CMD, clock signals CLK generated in a clock generator (not shown), and data DATA to the memory card 3200 via the host connecting unit 3120.

The memory card 3200 may be a compact flash card (CFC), a microdrive, a smart media card (SMC), a multimedia card (MMC), a security digital card (SDC), a memory stick, or a US flash memory driver.

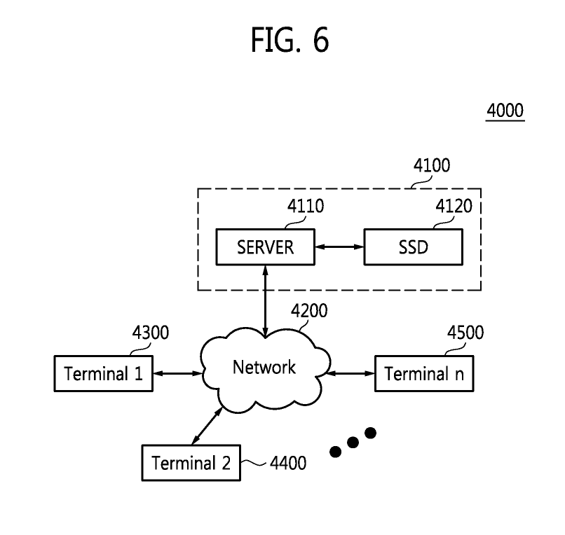

FIG. 6 is a block diagram showing an example of network configuration about a server system 4100 including an SSD according to an example embodiment of inventive concepts.

Referring to FIG. 6, the network system 4000 may include a server system 4100, and a plurality of terminals 4300, 4400, and 4500 connected to each other via a network 4200. The server system 4100 of the present embodiment may include a server 4110 processing requests transmitted from the plurality of terminals 4300, 4400, and 4500 connected to the network 4200, and an SSD 4120 storing data corresponding to the requests transmitted from the terminals 4300, 4400, and 4500. Here, the SSD 4120 may be the storage device 1200, shown in FIG. 1.

Meanwhile, the memory system according to inventive concepts may be mounted by using various types of packages. For example, the memory system according to inventive concepts may be mounted by using packages such as a package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metricquad flat pack (MQFP), thin quad flatpack (TQFP), small outline (SOIC), shrink small outline package (SSOP), thin small outline (TSOP), thin quad flatpack (TQFP), system in package (SIP), multi-chip package (MCP), wafer-level fabricated package (WFP), and wafer-level processed stack package (WSP).

The foregoing description of example embodiments has been provided for purposes of illustration and description. It is not intended to be exhaustive or limiting. Individual elements or features of a particular example embodiment are generally not limited to that particular example embodiment. For example, pre-processing may be performed on the encoder side. In other words, the sent file is not saved in its original form (as delivered by the host) but saved after a few modifications which may improve the process of delivering manipulated files (the pre-processing may or may not be reversible).

Rather, where applicable, individual elements or features are interchangeable and may be used in a selected embodiment, even if not specifically shown or described. The same may also be varied in many ways. All such modifications are intended to be included within the scope of this disclosure.

1. A memory storage device comprising:
a first memory; and
a memory controller for the memory storage device configured to,
read a file from the first memory upon receiving a request for the file from an external host, and
manipulate the file without any intervention by the external host in accordance with the request.

2. The memory storage device of claim 1, wherein the memory controller is further configured to identify requested manipulations from the request.

3. The memory storage device of claim 2, wherein the requested manipulations include at least one of contrast adjustment, color enhancement, rotation, skew adjustment, and resolution alteration.

4. The memory storage device of claim 1, wherein the memory controller is further configured to program a file into the first memory.

5. The memory storage device of claim 1, wherein the file is a multimedia file.

6. The memory storage device of claim 5, wherein the memory controller is configured to change a resolution of an image in the file based on the request, the manipulated file being a file with the image having the changed resolution.

7. The memory storage device of claim 6, wherein the memory controller is configured to send the manipulated file to the host.

8. The memory storage device of claim 6, wherein the first memory is configured to save only one copy of the image.

9. The memory storage device of claim 1, wherein the memory controller is configured to send the manipulated file to the host.

10. The memory storage device of claim 1, wherein the memory controller is configured to perform lossless decoding before manipulating the file.

11. The memory storage device of claim 10, wherein the memory controller is configured to perform lossless encoding of the manipulated file.

12. The memory storage device of claim 1, wherein the first memory includes a three-dimensional memory array.

13. A method of manipulating a multimedia file in a memory storage device comprising:
reading, by a memory controller for the memory storage device, the multimedia file from a first memory of the memory storage device upon receiving a request for the multimedia file from an external host; and
manipulating, by the memory controller, the multimedia file without any intervention by the external host in accordance with the request.

14. The method of claim 13, further comprising:
identifying requested manipulations from the request.

15. The method of claim 13, wherein the manipulating includes,
changing a resolution of an image in the multimedia file based on the request, the manipulated multimedia file being a multimedia file with the image having the changed resolution.

16. The method of claim 15, further comprising:
sending the manipulated multimedia file to the host.

17. The method of claim 15, wherein the programming programs only one copy of the image into the first memory.

18. The method of claim 17, further comprising:
processing the request such that the multimedia file is not passed to the host upon receiving the request.

19. The method of claim 13, further comprising:
performing lossless decoding before manipulating the multimedia file.

20. The method of claim 19, further comprising:
performing lossless encoding of the manipulated multimedia file.
